(19) United States
(12) Patent Application Publication
(10) Pub. No.: US 2019/0205929 A1
(43) Pub. Date: Jul. 4, 2019

(54) SYSTEMS AND METHODS FOR PROVIDING MEDIA EFFECT ADVERTISEMENTS IN A SOCIAL NETWORKING SYSTEM

(71) Applicant: Facebook, Inc., Menlo Park, CA (US)

(72) Inventors: Scott Snibbe, San Francisco, CA (US); Harshdeep Singh, Santa Clara, CA (US)

(21) Appl. No.: 15/856,946

(22) Filed: Dec. 28, 2017

(51) Int. Cl. G06Q 30/02; G06K 9/00; G06T 11/60; G06Q 50/00; G06N 99/00

(52) U.S. Cl. CPC G06Q 30/0251; G06K 9/00228; G06T 11/60; H04N 5/23293; G06N 99/005; G06Q 30/0277; G06Q 50/01

(57) ABSTRACT

Systems, methods, and non-transitory computer readable media can obtain a media content item created by a first user that includes a media effect that can be applied to image data in a camera view. A plurality of content items including the media content item can be ranked. A ranking of the media content item can be adjusted. The media content item can be provided to a second user, based on the adjusted ranking of the media content item.

### FIELD OF THE INVENTION

The present technology relates to the field of social networks. More particularly, the present technology relates to techniques for providing effects associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In some cases, content items can include media content items, such as images, videos, and audio. Content items can be presented on various surfaces, such as a profile page of a user or a feed of a user.

### SUMMARY

Various embodiments of the present disclosure can include systems, methods, and non-transitory computer readable media configured to obtain a media content item created by a first user that includes a media effect that can be applied to image data in a camera view. A plurality of content items including the media content item can be ranked. A ranking of the media content item can be adjusted. The media content item can be provided to a second user, based on the adjusted ranking of the media content item.

In some embodiments, the media effect is provided by a social networking system, and the media effect is created by an entity.

In certain embodiments, the media effect tracks one or more of a face or an object detected in the camera view.

In an embodiment, the media effect is created based on one or more of: targeting criteria, delivery settings, personalized settings, a trigger, or a call-to-action (CTA).

In some embodiments, a plurality of users including the first user can be identified based on the targeting criteria, and the media effect can be provided to the plurality of users.

In certain embodiments, a plurality of media effects including the media effect can be ranked, and the media effect can be provided to the first user based on the ranking the plurality of media effects.

In an embodiment, the ranking the plurality of media effects is based on a machine learning model.

In some embodiments, the media content item is provided to the second user with a call-to-action (CTA) accompanying the media content item, and the CTA provides access to the media effect to the second user.

In certain embodiments, the ranking of the plurality of content items including the media content item is adjusted by increasing a score of the media content item, wherein the score is indicative of a likelihood of engagement with the media content item by the second user.

In an embodiment, performance of the media effect can be measured, wherein the performance includes a count of actions relating to one or more of: a user seeing the media effect, a user trying the media effect, a user capturing an image or a video with the media effect, or a user sharing a captured image or video with the media effect.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example media effect advertisement module configured to provide media effect advertisements, according to an embodiment of the present disclosure.

FIG. 2A illustrates an example effect content item module configured to provide content items including media effects, according to an embodiment of the present disclosure.

FIG. 2B illustrates an example effect performance module configured to generate information regarding performance of media effects, according to an embodiment of the present disclosure.

FIG. 3A illustrates an example user interface for providing media effect advertisements, according to an embodiment of the present disclosure.

FIG. 3B illustrates an example user interface for providing media effect advertisements, according to an embodiment of the present disclosure.

FIG. 4 illustrates an example first method for providing media effect advertisements, according to an embodiment of the present disclosure.

FIG. 5 illustrates an example second method for providing media effect advertisements, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Media Effect Advertisements in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In some cases, content items can include media content items, such as images, videos, and audio. Content items can be presented on various surfaces, such as a profile page of a user or a feed of a user.

Conventional approaches specifically arising in the realm of computer technology can provide various effects that can be applied to media content items. For example, an effect can be shown in camera view of a user computing device and can be added to a captured media content item. A social networking system may create and provide effects that can be added to media content items to users of the social networking system. However, under conventional approaches, the social networking system may not provide a platform for entities to create and provide effects to users of the social networking system.

An improved approach rooted in computer technology can overcome the foregoing and other disadvantages associated with conventional approaches specifically arising in the realm of computer technology. Based on computer technology, the disclosed technology can provide a platform for entities to create and provide effects to users of a social networking system. An effect that can be applied to media content items can be referred to as a “media effect.” Media effects created by entities for application to media content items can be provided as a form of advertising within the social networking system. Accordingly, media effects can also be referred to as media effect advertisements. In this way, media effects can be considered an advertisement surface. Entities can create media effects by specifying required information, such as targeting criteria, delivery settings, personalization settings, and triggers. Created media effects can be provided to users based on associated criteria. Created media effects can be provided or delivered to users in various ways, for example, through an effects tray, a call-to-action, etc. If users create media content items that include media effects from third parties, the media content items including the media effects can be ranked along with other content items and provided on various surfaces (e.g., a feed of a user). In some cases, the media content items including the media effects can be boosted in ranking. Performance of media effects can be measured, and an analysis of media effects can be provided to entities associated with the media effects. In this manner, the disclosed technology can provide media effects created by entities to targeted users as advertisements. Additional details relating to the disclosed technology are provided below.

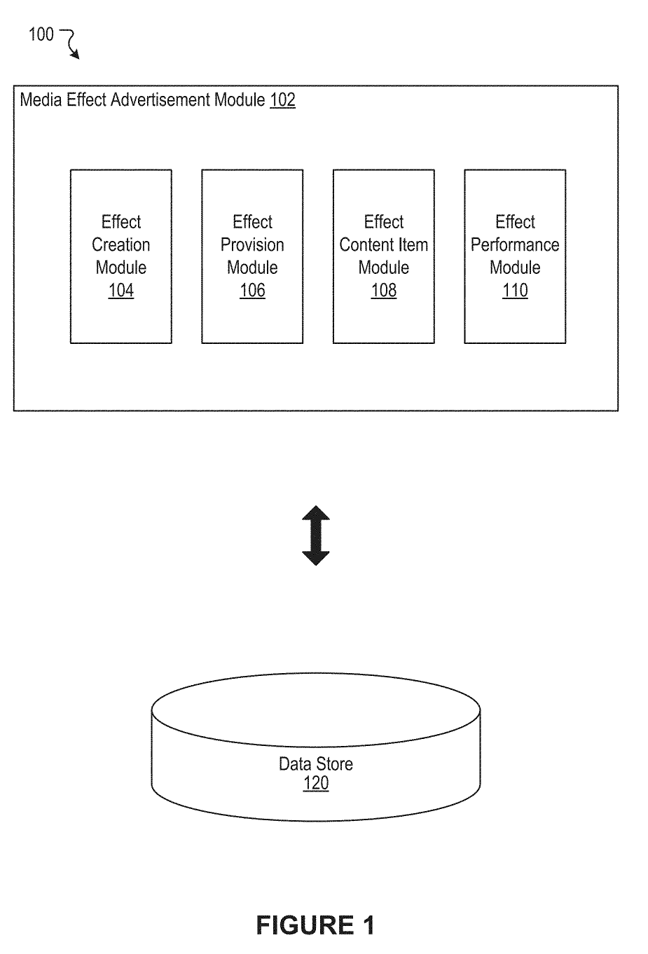

FIG. 1 illustrates an example system 100 including an example media effect advertisement module 102 configured to provide media effect advertisements, according to an embodiment of the present disclosure. The media effect advertisement module 102 can include an effect creation module 104, an effect provision module 106, an effect content item module 108, and an effect performance module 110. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the media effect advertisement module 102 can be implemented in any suitable combinations. While the disclosed technology is described in connection with media effect advertisements associated with a social networking system for illustrative purposes, the disclosed technology can apply to any other type of system and/or content.

A social networking system can provide a platform to allow entities to create media effects. Any entity (or “third party”) can create a media effect. In some embodiments, the entity can include any type of user of a social networking system, such as an individual, a company, an advertiser, etc. In some embodiments, the entity is not a manager, controller, or administrator of the social networking system. Media effects created by entities can be generated and distributed to users of the social networking system based on various criteria associated with the media effects. A media effect can indicate any media content that can be applied to image data shown in a camera view associated with a computing device of a user. For instance, the camera view can be provided in connection with an application associated with the social networking system and running on a user computing device. A media effect can be accessible from a camera view such that the media effect can be applied to and included in image data in the camera view before, during, and/or after capture of an image or a video. For example, a media effect can be provided in an effects tray associated with the camera view. An effects tray can be accessed from the camera view and can include various types of effects, including one or more media effects. A user can select a media effect from the effects tray in order to apply the media effect to image data in the camera view. In some cases, a media effect may track an object appearing in the camera view, such as a face of a person, before capture. A position of an object appearing in the camera view may change within the camera view, and the media effect can be provided at a current position of the object in the camera view. When an image or a video is captured in the camera view, the media effect can be included within the captured image or video. In this way, a camera view and/or media effects can be considered an advertisement surface or platform. Accordingly, media effects can also be referred to as “media effect advertisements.”

The effect creation module 104 can create media effects based on created and specified information. An entity can create and specify information for creating a media effect. Examples of such information can include targeting criteria, delivery settings, personalization settings, triggers, etc. Targeting criteria can indicate criteria for identifying target users of a media effect. Delivery settings can indicate settings associated with providing a media effect to users. Personalization settings can indicate settings associated with personalized or customized data in a media effect. A trigger can indicate one or more conditions that trigger provision of a media effect. In some embodiments, information for creating a media effect can also include one or more calls-to-action (CTAs). Many variations are possible.

The effect creation module 104 can provide a user interface through which an entity can create and specify information for creating a media effect. The entity can provide various types of information for creating a media effect in the user interface. As mentioned above, such information can include targeting criteria, delivery settings, personalization settings, triggers, etc. Targeting criteria can include various criteria for determining target users. In some embodiments, targeting criteria can be based on attributes or signals available from the social networking system. For example, targeting criteria can include user attributes. User attributes can include any attributes associated with users. Examples of user attributes can include a location (e.g., a country, state, county, city, etc.), an age, an age range, a gender, an interest, device information (e.g., mobile or desktop, operating system (OS), device type, etc.), preferences of a user, activities of a user within the social networking system, etc. Activities of a user can include interactions with other users, interactions with content items, including media content items, created by other users, interactions with pages, an interest or participation in events, etc. Pages can be dedicated locations on the social networking system to reflect the presence of various entities on the social networking system. Examples of entities can include companies, businesses, brands, products, artists, public figures, entertainment, individuals, etc. Many variations are possible. Targeting criteria can be specified at various levels of granularity. As an example, a media effect can target female users within an age range. As another example, a media effect can target users who are attending a particular event. In some embodiments, targeting criteria can also include a budget associated with a media effect. For example, a number of users targeted can vary depending on the budget for a media effect. In certain embodiments, targeting criteria can include any information used in advertisement targeting, for example, within the social networking system.

Delivery settings can include settings associated with providing a media effect and/or related content to users. The delivery settings can relate to various techniques of delivering a media effect to users. In general, a media effect can be delivered to targeted users in an effects tray in a camera view. An entity associated with a media effect can also select or indicate various options available for delivery of the media effect and/or related content in the delivery settings. For example, an entity can indicate in the delivery settings whether a media effect should be provided as a default media effect in the camera view. If a media effect is designated as a default media effect, the media effect can automatically be applied in the camera view when the camera view is initiated. Providing a media effect as a default media effect can lead to increased engagement with the media effect by users.

In some embodiments, content related to a media effect (“related content”) can also be provided to users, and an entity can indicate in the delivery settings whether a media effect should be provided or promoted to users through some or all types of the related content associated with the media effect. Related content of a media effect can appear on a surface that is not a camera view and provide users access to the media effect without having to directly navigate to the camera view. Related content of a media effect can indicate any type of content that includes or promotes the media effect. An example of related content can be a media content item including the media effect from an entity associated with media effect. For instance, an entity associated with a media effect can provide a video advertisement including the media effect to promote the media effect. As an example, if the media effect relates to a movie, the video advertisement can show the media effect applied to an actor who appears in the movie. Another example of related content can be a media content item including the media effect created by a user. For instance, if a user creates a media content item including the media effect, the media content item can be provided in a feed of another user, for example, as an advertisement for the media effect. A further example of related content can be a content item collection that is associated with the media effect. For instance, a content item collection can be created to include and promote media content items including the media effect from various users or entities. The content item collection can appear in a content item collection tray. A user can select the content item collection to view various media content items including the media effect. Related content of a media effect can include user interface (UI) elements (e.g., a button, an icon, a link, etc.) or CTAs that users can select in order to access the media effect. For example, in response to selection of a UI element or a CTA, a camera view can be initiated with the media effect automatically applied in the camera view, and the user can experience the media effect. In this way, a media effect can be promoted to users through related content of the media effect. Additional details relating to providing a media effect through related content of the media effect are described below, for example, in connection with the effect provision module 106.

Related content of a media effect can be provided on various surfaces. A surface can indicate any user interface or any portion of a user interface through which a media effect can be provided. In some embodiments, a surface can be determined or defined based on one or more of the following: a website, a webpage, a particular section of a webpage, an application, a particular page of an application, a particular section of a page of an application, an operating system (OS), a platform (e.g., mobile, desktop, etc.), a type of device, etc. In connection with a social networking system, examples of surfaces can include a feed of a user, a search, a timeline of a page, a profile of a user, an immersive viewer, etc. Many variations are possible.

Personalization settings can include settings associated with personalized or customized data in a media effect. A media effect can include one or more placeholders or fields that can be replaced with information specific to a particular user to whom the media effect is provided. For example, content of a media effect can include text, and the text can include one or more placeholder fields. Examples of placeholders can include a name of a user, a name of a family member or a friend, a birthday of a user, a profile photo of a user, a profile photo of a family member or a friend, etc. Many variations are possible. A placeholder can be replaced with an appropriate value or data when a media effect is provided to a particular user. In some embodiments, placeholders can be replaced on or by a computing device of a user. In other embodiments, placeholders can be replaced on or by a server associated with the social networking system.

A media effect can be provided to a user based on a trigger. A trigger can include one or more conditions that cause provision of a media effect. Examples of triggers can include a date, a date range (e.g., a start date and an end date), a birthday of a user, an anniversary, a holiday, etc. For example, if a trigger for a media effect is the birthday of a user, the media effect is provided to a user on the user's birthday. Many variations are possible.

A media effect can also include one or more CTAs. A CTA can indicate an action that an entity wants a user to take. For example, a CTA of a media effect for a movie can provide a link to access a website for the movie or a website for purchasing tickets. In some embodiments, a CTA can be provided within a media effect. In other embodiments, a CTA can be provided in related content of a media effect. A CTA can be provided as a UI element, such as a button, an icon, or a link.

An entity can also provide content of a media effect. The content of a media effect can include media effect data that can be applied in the camera view. The content of a media effect can include various types of data, such as text, video, audio, image, animation, etc. In some embodiments, an entity can create the content of a media effect in an editor tool for creating media effects. For example, the editor tool can be provided by the social networking system. In other embodiments, an entity can import or upload a media effect or the content of a media effect from another source.

The effect creation module 104 can create a media effect based on some or all of information for creating a media effect as described above. A created media effect can be provided to users, for example, by the effect provision module 106, as described below. In certain embodiments, a media effect can be a part of a media effect pack. A media effect pack can include one or more media effects that are related. For example, a movie can include multiple characters, and there can be a media effect for each character. The media effects for the characters in the movie can be provided as a media effect pack. For example, a media effect pack can be provided in an effects tray. In some embodiments, a portion of or all information for creating a media effect can apply to or otherwise be used to create all media effects in a media effect pack. In other embodiments, information for creating a media effect in a media effect pack can be specified for a particular media effect or a group of media effects in the media effect pack. All examples herein are provided for illustrative purposes, and there can be many variations and other possibilities.

The effect provision module 106 can provide created media effects. A created media effect can be provided or delivered to users based on specified information for creating the media effect, as described above. For example, a media effect can be provided based on associated targeting criteria, delivery settings, personalization settings, triggers, CTAs, related content, etc.

Target users for a media effect can be determined based on targeting criteria associated with a media effect. As described above, target users may be identified based on user attributes, such as a location, an age, an age range, a gender, an interest, etc. In some embodiments, target users for a media effect can be identified based on machine learning techniques. For example, a machine learning model can be trained based on various features associated with users in order to identify target users who are likely to use a media effect. In some embodiments, features can relate to any of user attributes mentioned above. In certain embodiments, features can also relate to creators of media effects, content of media effects, previous engagement of users with media effects, etc. Many variations are possible.

A media effect can be accessed by or made available to a user in various ways, for example, based on delivery settings associated with the media effect. For example, a user can navigate directly to a camera view of a computing device associated with user, and the effect provision module 106 can present a media effect in an effects tray or apply a media effect to the camera view. In some instances, a user initiates the camera view, and the effect provision module 106 can automatically select and apply a media effect to image data in the camera view. In some embodiments, at least some of the ways in which a user can access a media effect can be through related content of the media effect, as described above. As an example, the effect provision module 106 can provide a media content item that includes a media effect and an associated CTA on a particular surface. For instance, the media content item can be from an entity or another user. The CTA can specify an action that can be taken in connection with the media effect in the media content item. In some cases, the CTA itself can prompt a user to apply the media effect to a media content item or to save the media effect for later application. If the CTA prompts a user to apply the media effect to a media content item, selection the CTA by the user can initiate a camera view with the media effect presented or applied in the camera view. If the CTA prompts a user to save a media effect for later application, selection of the CTA by the user can save the media effect, for example, to an effects tray in the camera view. The media content item including the media effect can appear on various surfaces, such as a feed of the user. For instance, the media content item can be provided in the user's newsfeed as a post. As another example, the effect provision module 106 can provide a content item collection that includes media content items including a media effect. For instance, the content item collection can be provided in a content item collection tray. A content item collection may be associated with a particular media effect or a particular user. In some embodiments, the content item collection can be ephemeral and expire after a time period. The user can select the content item collection, and the effect provision module 106 can provide a media content item with the media effect, for example, within an immersive viewer. The media content item with the media effect can include an associated CTA, for example, for applying the media effect or saving the media effect for later. In certain embodiments, a media effect may be made available to a user only in responding to a certain content item. For instance, an entity may only allow a user to apply the media effect if the user is replying to a media content item including the media effect created by the entity.

In some embodiments, the effect provision module 106 can rank media effects to determine which media effect(s) should be provided to a user and/or an order in which media effect(s) should be provided to a user. In some embodiments, media effects can be ranked based on machine learning techniques. A machine learning model can be trained to rank and select one or more media effects for users based on a likelihood of users engaging with media effects. For example, a user can engage with a media effect by selecting the media effect for application to a media content item. The machine learning model can be trained based on training data including media effects and labels indicating whether users have engaged with the media effects. The training data can include various features. For example, features can relate to any of user attributes mentioned above. Features can also relate to creators of media effects, content of media effects, previous engagement of users with media effects, etc. The machine learning model can determine weights associated with various features used to train the machine learning model. The trained machine learning model can be applied to rank media effects for a particular user based on a likelihood of the user engaging with the media effects. For example, the trained machine learning model can output a score indicative of a likelihood of the user engaging with a media effect. In some embodiments, the effect provision module 106 can provide a ranked media effect to a user if the score of the ranked media effect satisfies a threshold value. Media effects can be ordered based on respective scores. One or more top ranked media effects can be provided in an effects tray of the user. In some embodiments, a number of media effects included in the effects tray of the user can be determined based on available slots or spaces in the effects tray. One or more machine learning models discussed in connection with the media effect advertisement module 102 and its components can be implemented separately or in combination, for example, as a single machine learning model, as multiple machine learning models, as one or more staged machine learning models, as one or more combined machine learning models, etc. In some embodiments, a media effect can be provided as a first effect or a first media effect in the effects tray even if the media effect does not have the highest score. For example, there can be an option for an entity to have a media effect displayed as the first effect or the first media effect in the effects tray. The option can be provided as a part of the information for creating the media effect, for example, in the delivery settings. For instance, the entity can pay for the option. All examples herein are provided for illustrative purposes, and there can be many variations and other possibilities.

The effect content item module 108 can provide content items including media effects. The effect content item module 108 can provide media content items created by users that include media effects through various surfaces. The effect content item module 108 can also rank media content items including media effects. Functionality of the effect content item module 108 is described in more detail herein.

The effect performance module 110 can generate information regarding performance of media effects. The effect performance module 110 can measure performance of media effects. The effect performance module 110 can also provide analysis of media effects based on measured performance. Functionality of the effect performance module 110 is described in more detail herein.

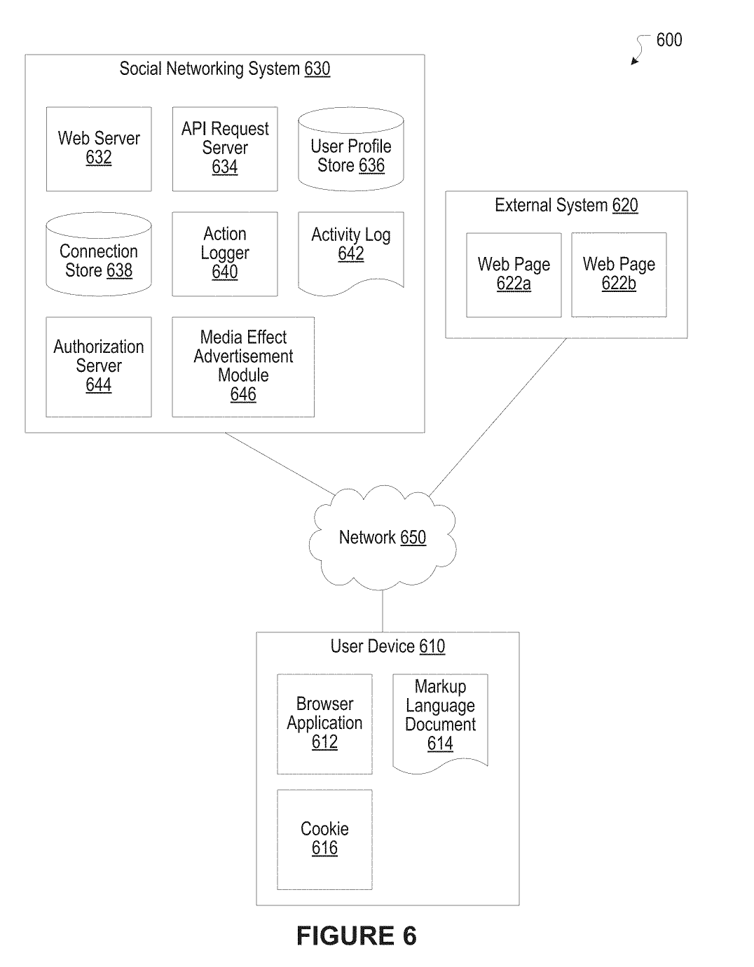

In some embodiments, the media effect advertisement module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the media effect advertisement module 102 can be, in part or in whole, implemented as software running on one or more computing devices or systems, such as on a server system or a client computing device. In some instances, the media effect advertisement module 102 can be, in part or in whole, implemented within or configured to operate in conjunction or be integrated with a social networking system (or service), such as a social networking system 630 of FIG. 6. Likewise, in some instances, the media effect advertisement module 102 can be, in part or in whole, implemented within or configured to operate in conjunction or be integrated with a client computing device, such as the user device 610 of FIG. 6. For example, the media effect advertisement module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the media effect advertisement module 102. The data maintained by the data store 120 can include, for example, information relating to media effects, third parties, information for creating media effects, provision or delivery of media effects, content items including media effects, performance and/or analysis of media effects, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the media effect advertisement module 102 can be configured to communicate and/or operate with the data store 120. In some embodiments, the data store 120 can be a data store within a client computing device. In some embodiments, the data store 120 can be a data store of a server system in communication with the client computing device.

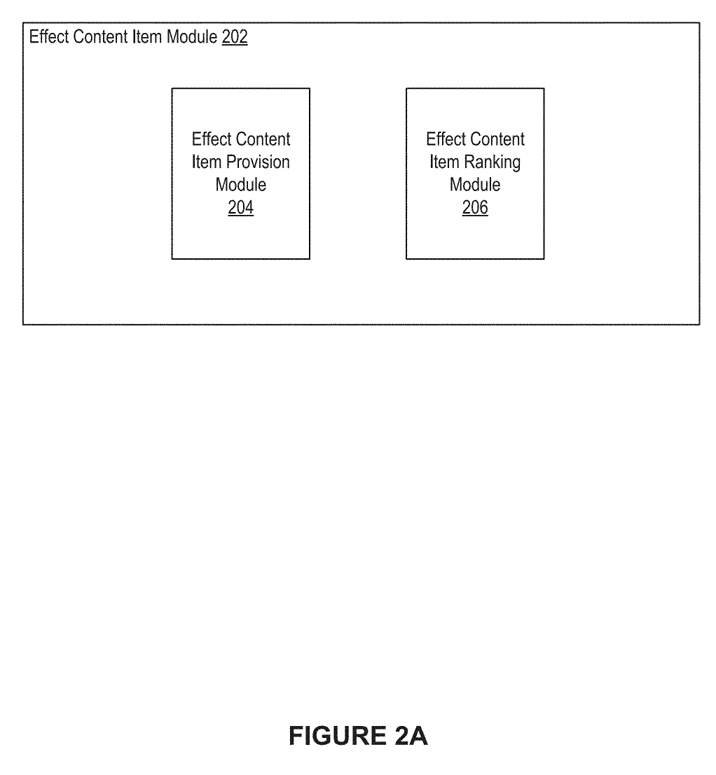

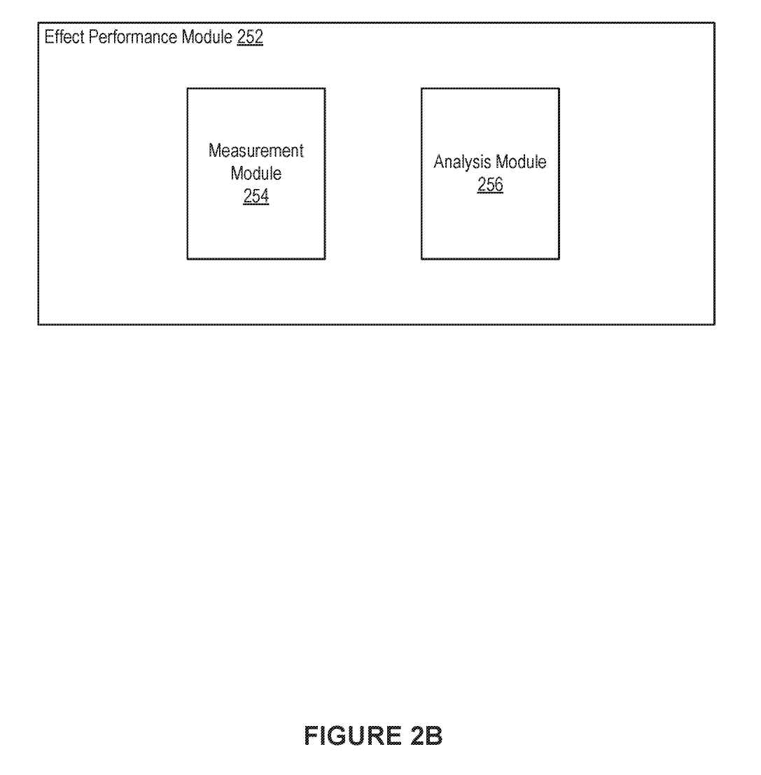

FIG. 2A illustrates an example effect content item module 202 configured to provide content items including media effects, according to an embodiment of the present disclosure. In some embodiments, the effect content item module 108 of FIG. 1 can be implemented with the example effect content item module 202. As shown in the example of FIG. 2A, the example effect content item module 202 can include an effect content item provision module 204 and an effect content item ranking module 206.

The effect content item provision module 204 can provide media content items created by users that include media effects through various surfaces. Once a user has activated a camera view in a user computing device and has access to a media effect presented in the camera view, the user can see the media effect, try the media effect, capture image data in the camera view to create a media content item including the media effect, and/or share a captured media content item including the media effect. A shared media content item of a user can be provided to other users on various surfaces. As an example, the media content item including the media effect can be provided in a feed of another user, such as a connection of the user (e.g., a friend or a follower of the user). As another example, the media content item including the media effect can be included in a content item collection of a user. For instance, a content item collection of a user can include one or more content items created by the user. In certain embodiments, content items included in a content item collection of a user can be ephemeral and can expire after a time period. In some embodiments, ephemeral content item collections can be referred to as “stories.” In some cases, the user can expressly share a media content item including a media content effect. In other cases, a media content item including a media effect is shared upon creation of the media content item due to characteristics of the media content item (e.g., stories). For example, a media content item that is part of an ephemeral content item collection can automatically be shared upon creation because any content included in the ephemeral content item collection is shared with one or more other users.

The effect content item ranking module 206 can rank media content items including media effects. Various content items can be ranked for inclusion on a surface, such as a feed of a user. For example, a score can be determined for each content item that is a candidate for inclusion on a surface, and candidate content items can be ranked based on respective scores. In some embodiments, the score for a content item can be indicative of a likelihood of a user engaging with the content item. For instance, a user may engage with a content item by selecting the content item, for example, by a click, a touch gestures, etc. Media content items including media effects can also be ranked along with other content items to be provided on a surface. In some embodiments, scores or rankings of media content items including media effects can be adjusted or boosted to be higher so that the media content items will have more visibility to users. For instance, a score or rank of a media content item including a media effect can be increased or boosted by a value. In other embodiments, media content items including media effects can be assigned a particular score. For instance, with respect to another type of boosting, all media content items including media effects can be assigned a specific value as their scores, which may be higher than scores for other content items. In this way, a media content item including a media effect in comparison to other types of content items can have a higher likelihood of being presented to a user or can have more prominence when presented to the user. As an example, if a media content item including a media effect is provided in a feed of a user, the media content item can appear in the feed as a more highly ranked content item. In this regard, the media content item can appear in the feed at a higher position, with more prominence (e.g., larger display), or with a special reference (e.g., an indication of emphasis). The effect content item ranking module 206 can rank content items, including media content items, based on machine learning techniques. For example, a machine learning model can be trained based on various features to rank content items.

There can also be other techniques of adjusting or boosting media content items including media effects. In some embodiments, an ephemeral content item collection otherwise subject to expiration after a first duration of time can include a media content item that includes a media effect. In such embodiments, an expiration of the particular media content item and/or the ephemeral content item collection can be extended such that the particular media content item and/or the ephemeral content item collection can instead expire at a second duration of time that is longer than the first duration of time. In this way, the media content item including the media effect can be accessible to other users for an extended period of time. All examples herein are provided for illustrative purposes, and there can be many variations and other possibilities.

FIG. 2B illustrates an example effect performance module 252 configured to generate information regarding performance of media effects, according to an embodiment of the present disclosure. In some embodiments, the effect performance module 110 of FIG. 1 can be implemented with the example effect performance module 252. As shown in the example of FIG. 2B, the example effect performance module 252 can include a measurement module 254 and an analysis module 256.

The measurement module 254 can measure performance of media effects. Performance can be measured for various actions associated with media effects. Examples of actions can include a user seeing a media effect, trying the media effect, capturing an image or video with the media effect, and sharing the image or video including the media effect. In some embodiments, the measurement module 254 can count instances (or impressions) of each of these actions. For example, an instance of a user seeing a media effect can be counted when a user sees the media effect in a camera view or in an effects tray. An instance of a user trying a media effect can be counted when a user selects or interacts with the media effect in a camera view. An instance of a user capturing an image or video can be counted when a user captures an image or a video with the media effect. An instance of a user capturing an image or video can be recognized and counted without having access to a captured image or video. For example, such an instance can be determined when a shutter button in a camera view is selected by a user. An instance of a user sharing an image or video with a media effect can be counted when a user shares a captured image or video with the media effect.

Payment by entities for media effects can be structured in various ways. In some embodiments, an entity can pay for each of the actions discussed above relating to a user seeing a media effect, trying the media effect, capturing an image or video with the media effect, and sharing the image or video including the media effect. An entity can also pay for each option available in creation of a media effect, such as various options in delivery settings. For example, an entity can pay for an option to provide a media effect through related content of the media effect, such as media content items including the media effect created by the entity or users, as described above. In certain embodiments, an entity can pay to provide the media effect to targeted users initially, pay to boost any media content items that the targeted users create using the media effect, and pay for any additional exposure of the media effect to users from the boosted media content items including the media effect. In turn, the entity can also pay to boost any media content items including the media effect that are created due to the additional exposure. In some embodiments, users who receive the additional exposure may also include users who do not meet all of targeting criteria associated with the media effect, such as connections of a targeted user. Many variations are possible.

The analysis module 256 can provide analysis of media effects based on measured performance. Analysis of media effects can be provided in real time. In some embodiments, a dashboard or another tool can be available to entities to access analysis of associated media effects. Analysis of a media effect can include any appropriate information associated with performance of the media effect. Examples of such information can include counts of actions associated with media effects, statistics, metrics, payment or cost information, etc. Many variations are possible. All examples herein are provided for illustrative purposes, and there can be many variations and other possibilities.

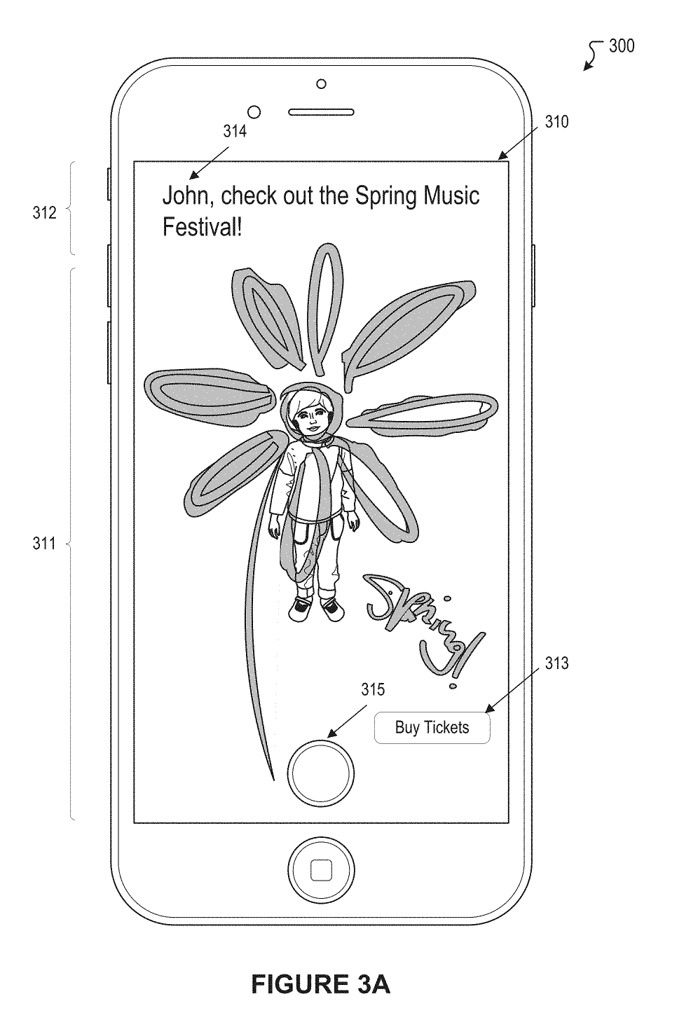

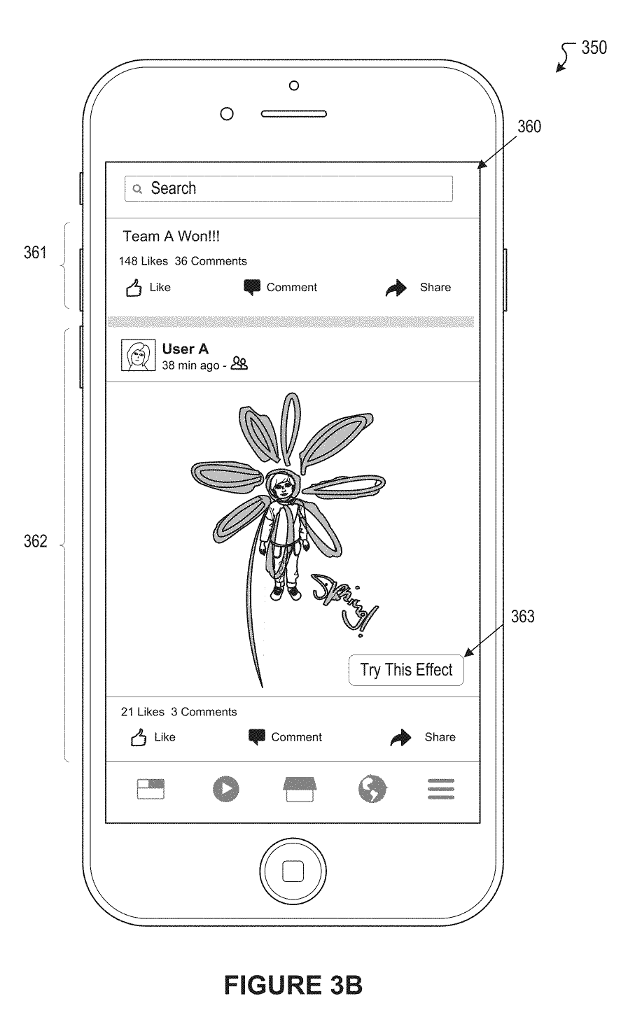

FIG. 3A illustrates an example user interface 300 for providing media effect advertisements, according to an embodiment of the present disclosure. The user interface 300 shows a camera view 310 of a user computing device associated with a user in which a media effect 311 is provided. For example, the media effect 311 can be generated by the media effect advertisement module 102, as described herein. In the example of FIG. 3A, the camera view 310 displays subject matter with the media effect 311 applied. In this example, the subject matter is a person, and the media effect 311 relates to an event. In particular, the media effect 311 is an artistic drawing of a flower with an adjacent, stylized reference to “Spring!” In some embodiments, the media effect 311 can track a detected face or object, such that the media effect 311 moves in the camera view 310 according to the position of the face or object. The media effect 311 can include personalized data about the user who is accessing the camera view 310. For example, the media effect 311 can include a name 314 of the user as personalized data. An entity can indicate a placeholder for the name of a user when creating the media effect 311, and the placeholder can be replaced with the name 314 when the media effect 311 is provided to the user. The media effect 311 can also include a CTA 313. In the example of FIG. 3A, the CTA 313 relates to buying tickets for the event. The user can capture an image or a video that includes the media effect 311 by selecting a shutter button 315. A captured image or video that includes the media effect 311 can be shared by the user. All examples herein are provided for illustrative purposes, and there can be many variations and other possibilities.

FIG. 3B illustrates an example user interface 350 for providing media effect advertisements, according to an embodiment of the present disclosure. The user interface 350 shows a feed 360 (e.g., newsfeed) of a user. The feed 360 can include one or more content items. In the example of FIG. 3B, the feed 360 includes content items 361, 362. The content item 362 is or includes a media content item with a media effect. For instance, the content item 362 can be a captured image or video from FIG. 3A. In the example of FIG. 3B, User A shared a captured image or video as created in the scenario depicted in FIG. 3A. In response to sharing of the captured image or video, the content item 362 can appear in the feed 360. The content item 362 includes the media effect 311 shown in FIG. 3A. The feed 360 is associated with another user (User B) who is a connection of User A. The content items that are candidates for the feed 360 can be ranked by the media effect advertisement module 102, as described herein. The content item 362 can appear in the current position in the feed 360 due to boosting. For example, a score of the content item 362 can be increased because the content item 362 is a media content item including a media effect. The content item 362 can include a CTA 363 for trying the media effect. The user can select the CTA 363, and a camera view of a user computing device associated with User B can be initiated with the media effect applied to the camera view. All examples herein are provided for illustrative purposes, and there can be many variations and other possibilities.

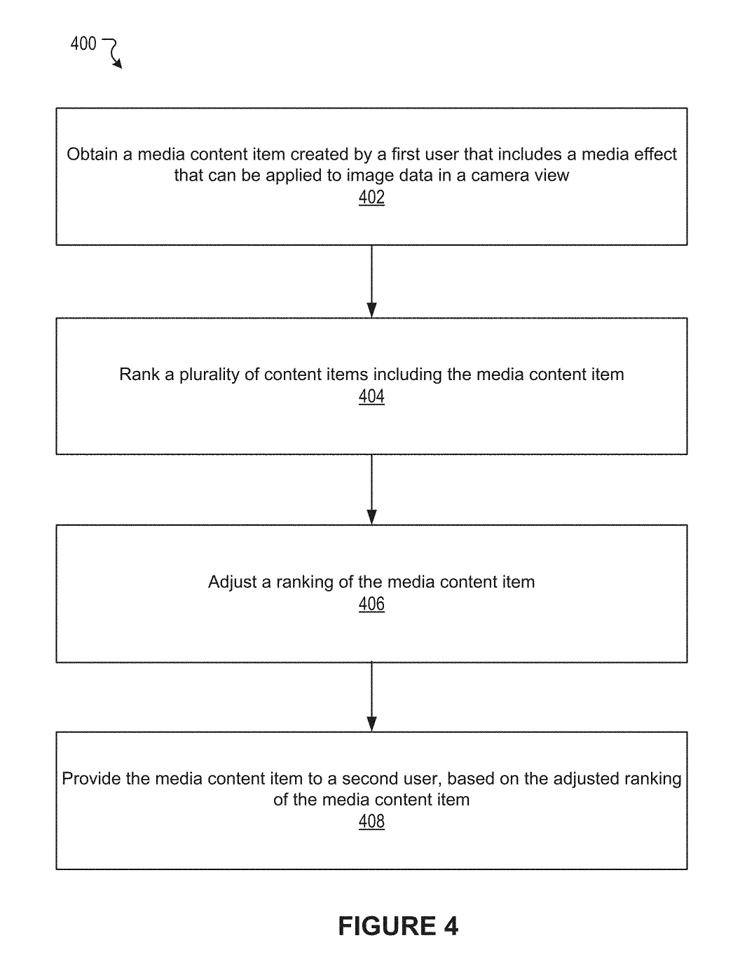

FIG. 4 illustrates an example first method 400 for providing media effect advertisements, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a media content item created by a first user that includes a media effect that can be applied to image data in a camera view. At block 404, the example method 400 can rank a plurality of content items including the media content item. At block 406, the example method 400 can adjust a ranking of the media content item. At block 408, the example method 400 can provide the media content item to a second user, based on the adjusted ranking of the media content item. Other suitable techniques that incorporate various features and embodiments of the present disclosure are possible.

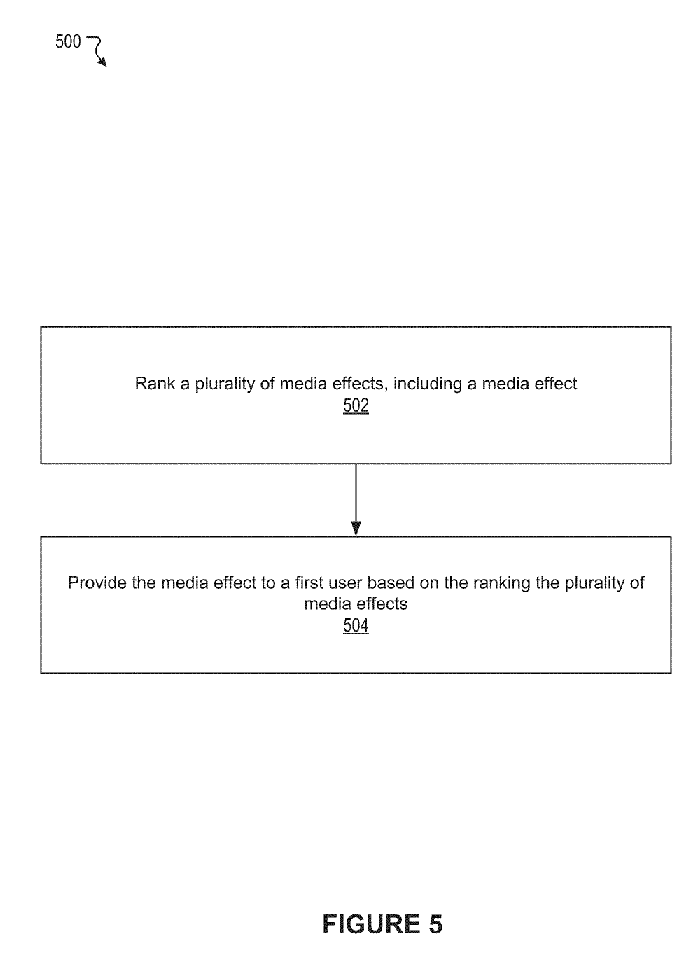

FIG. 5 illustrates an example second method 500 for providing media effect advertisements, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can rank a plurality of media effects, including a media effect. The media effect can be similar to the media effect explained in connection with FIG. 4. At block 504, the example method 500 can provide the media effect to a first user based on the ranking the plurality of media effects. The first user can be similar to the first user explained in connection with FIG. 4. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a media effect advertisement module 646. The media effect advertisement module 646 can be implemented with the media effect advertisement module 102, as discussed in more detail herein. In some embodiments, one or more functionalities of the media effect advertisement module 646 can be implemented in the user device 610.

### Hardware Implementation

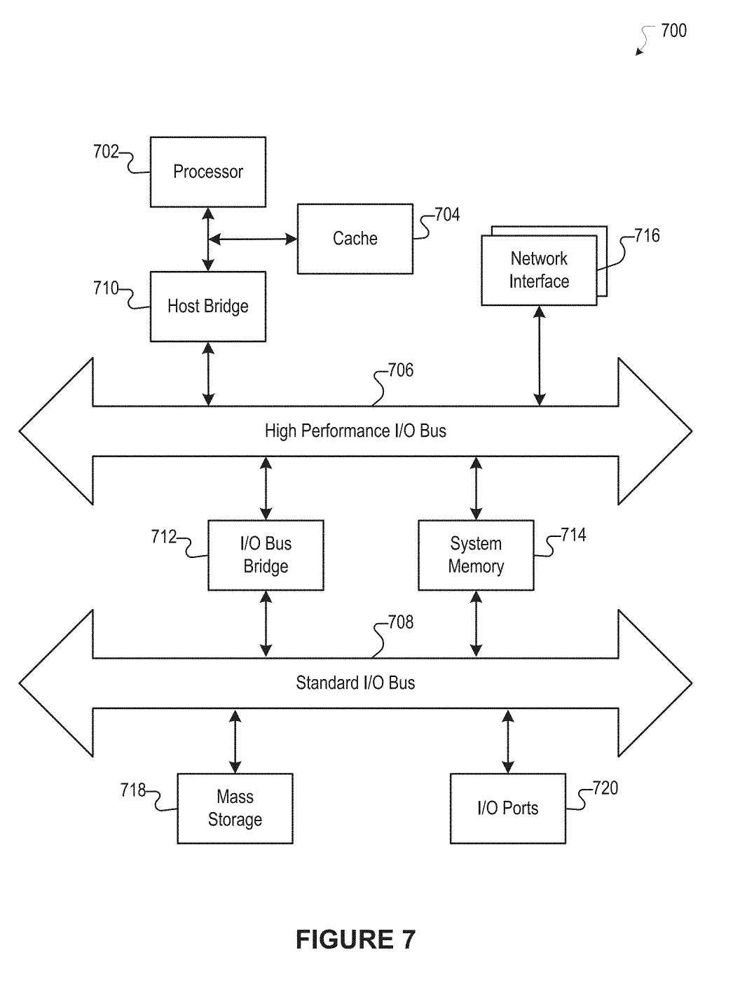

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a media content item created by a first user that includes a media effect that can be applied to image data in a camera view;
ranking, by the computing system, a plurality of content items including the media content item;
adjusting, by the computing system, a ranking of the media content item; and
providing, by the computing system, the media content item to a second user based on the adjusted ranking of the media content item.

2. The computer-implemented method of claim 1, wherein the media effect is provided by a social networking system and the media effect is created by an entity.

3. The computer-implemented method of claim 1, wherein the media effect tracks one or more of a face or an object detected in the camera view.

4. The computer-implemented method of claim 1, wherein the media effect is created based on one or more of: targeting criteria, delivery settings, personalized settings, a trigger, or a call-to-action (CTA).

5. The computer-implemented method of claim 4, further comprising:
identifying a plurality of users including the first user based on the targeting criteria; and
providing the media effect to the plurality of users.

6. The computer-implemented method of claim 1, further comprising ranking a plurality of media effects including the media effect, and wherein the media effect is provided to the first user based on the ranking the plurality of media effects.

7. The computer-implemented method of claim 6, wherein the ranking the plurality of media effects is based on a machine learning model.

8. The computer-implemented method of claim 1, wherein the media content item is provided to the second user with a call-to-action (CTA) accompanying the media content item, and wherein the CTA provides access to the media effect to the second user.

9. The computer-implemented method of claim 1, wherein the ranking of the plurality of content items including the media content item is adjusted by increasing a score of the media content item, wherein the score is indicative of a likelihood of engagement with the media content item by the second user.

10. The computer-implemented method of claim 1, further comprising measuring performance of the media effect, wherein the performance includes a count of actions relating to one or more of: a user seeing the media effect, a user trying the media effect, a user capturing an image or a video with the media effect, or a user sharing a captured image or video with the media effect.

11. A system comprising:
at least one hardware processor; and
a memory storing instructions that, when executed by the at least one processor, cause the system to perform:
obtaining a media content item created by a first user that includes a media effect that can be applied to image data in a camera view;
ranking a plurality of content items including the media content item;
adjusting a ranking of the media content item; and
providing the media content item to a second user, based on the adjusted ranking of the media content item.

12. The system of claim 11, wherein the media effect is provided by a social networking system and the media effect is created by an entity.

13. The system of claim 11, wherein the instructions further cause the system to perform ranking a plurality of media effects including the media effect, and wherein the media effect is provided to the first user based on the ranking the plurality of media effects.

14. The system of claim 11, wherein the media content item is provided to the second user with a call-to-action (CTA) accompanying the media content item, and wherein the CTA provides access to the media effect to the second user.

15. The system of claim 11, wherein the ranking of the plurality of content items including the media content item is adjusted by increasing a score of the media content item, wherein the score is indicative of a likelihood of engagement with the media content item by the second user.

16. A non-transitory computer readable medium including instructions that, when executed by at least one hardware processor of a computing system, cause the computing system to perform a method comprising:
obtaining a media content item created by a first user that includes a media effect that can be applied to image data in a camera view;
ranking a plurality of content items including the media content item;
adjusting a ranking of the media content item; and
providing the media content item to a second user, based on the adjusted ranking of the media content item.

17. The non-transitory computer readable medium of claim 16, wherein the media effect is provided by a social networking system and the media effect is created by an entity.

18. The non-transitory computer readable medium of claim 16, wherein the method further comprises ranking a plurality of media effects including the media effect, and wherein the media effect is provided to the first user based on the ranking the plurality of media effects.

19. The non-transitory computer readable medium of claim 16, wherein the media content item is provided to the second user with a call-to-action (CTA) accompanying the media content item, and wherein the CTA provides access to the media effect to the second user.

20. The non-transitory computer readable medium of claim 16, wherein the ranking of the plurality of content items including the media content item is adjusted by increasing a score of the media content item, wherein the score is indicative of a likelihood of engagement with the media content item by the second user.
